(19) United States
(12) Patent Application Publication
(10) Pub. No.: US 2007/0291415 A1
(43) Pub. Date: Dec. 20, 2007

(54) HEAD STACK ASSEMBLY AND HARD DISK DRIVE INCLUDING THE HEAD STACK ASSEMBLY

(75) Inventors: Yong-han SONG, Suwon-si (KR); Woo-sung KIM, Gangnam-gu (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 11/762,248

(22) Filed: Jun. 13, 2007

(30) Foreign Application Priority Data
Jun. 14, 2006 (KR) 10-2006-0053554

(51) Int. Cl. G11B 5/48

(52) U.S. Cl. 360/244.2

(57) ABSTRACT

A head stack assembly (HSA) is provided. The head stack assembly includes a swing arm including a core pivotally coupled to a base member of a hard disk drive (HDD) and at least one arm blade extending from the core in a horizontal direction, a suspension extending from an extreme end of the arm blade, and a head slider mounted on an extreme end of the arm blade for reading and writing data from or to a data storage disk of the HDD. The swing arm further includes a blade extension portion extending from the arm blade toward the core to prevent an interference with the data storage disk of the hard disk drive, and a rigidity weakening portion formed on a side opposite to that where the blade extension portion is formed to attenuate a rigidity difference in a lateral direction of the arm blade, which is caused by the blade extension portion.

### CROSS-REFERENCE TO RELATED PATENT APPLICATION

This application claims the benefit of Korean Patent Application No. 10-2006-0053554, filed on Jun. 14, 2006, in the Korean Intellectual Property Office, the disclosure of which is incorporated herein in its entirety by reference.

### BACKGROUND OF THE INVENTION

1. Field of the Invention

The present invention relates to a hard disk drive, and more particularly, to a head stack assembly that can reduce the size of an off-track which is caused by a vibration.

2. Description of the Related Art

Generally, a hard disk drive (HDD) is a device including auxiliary memory units that are used in a computer, an MP3 player, a mobile phone, and the like. That is, the HDD is a device that writes or reads data from or to a data storage disk using a data writing/reading medium such as a head slider. When the HDD operates, the head slider maintains a floating state where it is lifted off from the data storage disk by a predetermined gap. A magnetic head formed on the head slider reads or writes the data from or to the data storage disk.

The head slider is attached to an extreme end of a head stack assembly (HSA). That is, the head slider is moved to a target location of the data storage disk by the HSA.

FIG. 1 is a top view of a conventional HSA and FIG. 2 is a side view of the HSA shown in FIG. 1.

Referring to FIGS. 1 and 2, a conventional HSA 20 includes a swing arm 25 having a core 26 pivotally coupled to a base member (not shown) by a pivot bearing 22, and an arm blade 27 extending from the core 26 in a horizontal direction, a suspension 33 attached to an extreme end of the arm blade 27 by a coupling plate 31, and a head slider 35 mounted on an extreme end of the suspension 33. The HSA further includes an overmold 23, which is coupled to the core 26 and has a voice coil 24. The swing arm 25 includes a blade extension portion 28 extending from the arm blade 27 toward the core 26 so that the disk 10 does not interfere with the rotation of the HSA 20. The head slider 35 mounted on the extreme end of the HSA 20 writes or read the data to or from a specific track T of the disk 10 in a state where it is lifted off from the disk 10.

Meanwhile, when the data storage disk 10 and the head slider 35 vibrate due to the operation of the spindle motor 5 and the HSA 20 or other external impacts, the head slider 35 may stray off from the specific track T. This phenomenon is called off-track. The off-track is caused by the vibration of the data storage disk 10 at a specific vibration frequency, which is applied to the hard disk drive, or by the vibration of the HSA 20 at another specific vibration frequency, which is applied to the hard disk drive.

As shown in FIG. 2, the off-track caused by a vertical fluctuation of the arm blade 27 is an off-track caused by an arm bending. When the arm blade 27 moves upward, the suspension 33 is bent to displace the head slider 35 from a normal position depicted by a solid-line to an abnormal position depicted by an imaginary line (i). When the arm blade 27 moves downward, the suspension 33 is flattened to displace the head slider 35 to a position depicted by an imaginary line (ii).

However, due to the blade extension portion 28, the stiffness of the arm blade 27 becomes asymmetric with reference to a central line L1 of the HSA 20. As a result, the arm blade 27 may be twisted when it fluctuates vertically. Therefore, when the arm blade 27 moves upward, the head slider 35 deviates from the central line L1 to be displayed the position depicted by the imaginary line (i). In addition, when the arm blade 27 moves downward, the head slider 35 deviates from the central line to be displaced to the position depicted by the imaginary line (ii). Therefore, the off-track is more enlarged than a case where the head slider 35 fluctuates vertically at the central line L1.

### SUMMARY OF THE INVENTION

The present invention provides a head stack assembly (HSA) that can reduce the size of the off-track caused by an arm bending and a hard disk drive having the HSA.

According to an aspect of the present invention, there is provided a head stack assembly including: a swing arm including a core pivotally coupled to a base member of a hard disk drive and at least one arm blade extending from the core in a horizontal direction; a suspension extending from an extreme end of the arm blade; and a head slider mounted on an extreme end of the arm blade to read and write data from or to a data storage disk of the hard disk drive, wherein the swing arm further includes a blade extension portion extending from the arm blade toward the core to prevent an interference with the data storage disk of the hard disk drive a rigidity weakening portion formed on a side opposite to that where the blade extension portion is formed to attenuate a rigidity difference in a lateral direction of the arm blade, which is caused by the blade extension portion.

According to another aspect of the present invention, there is provided a hard disk assembly having the head stack assembly.

The rigidity weakening portion may be a dent formed on the arm blade.

A section of the dent may be formed in a shape selected from the group consisting of a triangular shape, a rectangular shape, a semi-circular shape, and a parabolic shape.

A depth of the dent indented from an outer circumference of the arm blade may be less than ½ of a width of the arm blade at a portion where the dent is formed.

The rigidity weakening portion may be formed at a boundary between the core and the arm blade.

The swing arm has more than two arm blades, and each of the arm blades may have the rigidity weakening portion.

The blade extension portion and the rigidity weakening portion may be respectively formed at opposite sides with reference to an imaginary line connecting the head slider and the rotational center of the head stack assembly.

### BRIEF DESCRIPTION OF THE DRAWINGS

The above and other features and advantages of the present invention will become more apparent by describing in detail exemplary embodiments thereof with reference to the attached drawings in which:

FIG. 1 is a side view of a top view of a conventional head stack assembly (HSA);

FIG. 2 is a side view of the HSA illustrated in FIG. 1;

FIG. 3 is a top view of a hard disk drive (HDD) according to an embodiment of the present invention;

FIG. 4 is a side view of an HSA according to an embodiment of the present invention;

FIGS. 5 through 7 are top views of HSAs according to other embodiments of the present invention;

FIGS. 8A through 8C are graphs illustrating a relationship between a size of the off-track and a vibration frequency applied to the HSA illustrated in FIGS. 1 and 2; and

FIGS. 9A through 9C are graphs illustrating a relationship between a size of the off-track and a vibration frequency applied to the HSA illustrated in FIGS. 3 and 4.

### DETAILED DESCRIPTION OF THE INVENTION

The present invention will now be described more fully with reference to the accompanying drawings, in which exemplary embodiments of the invention are shown.

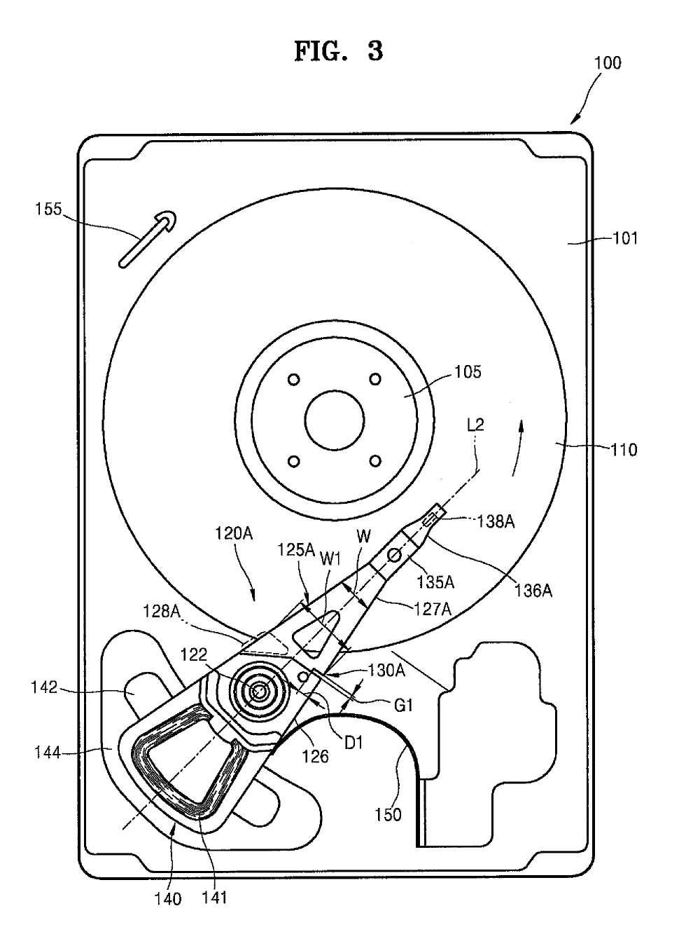

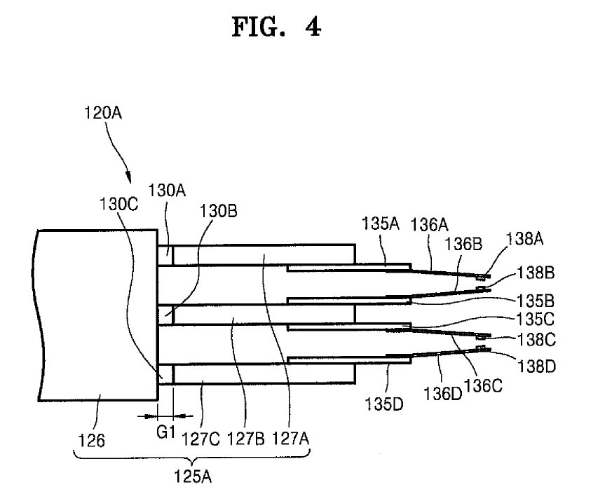

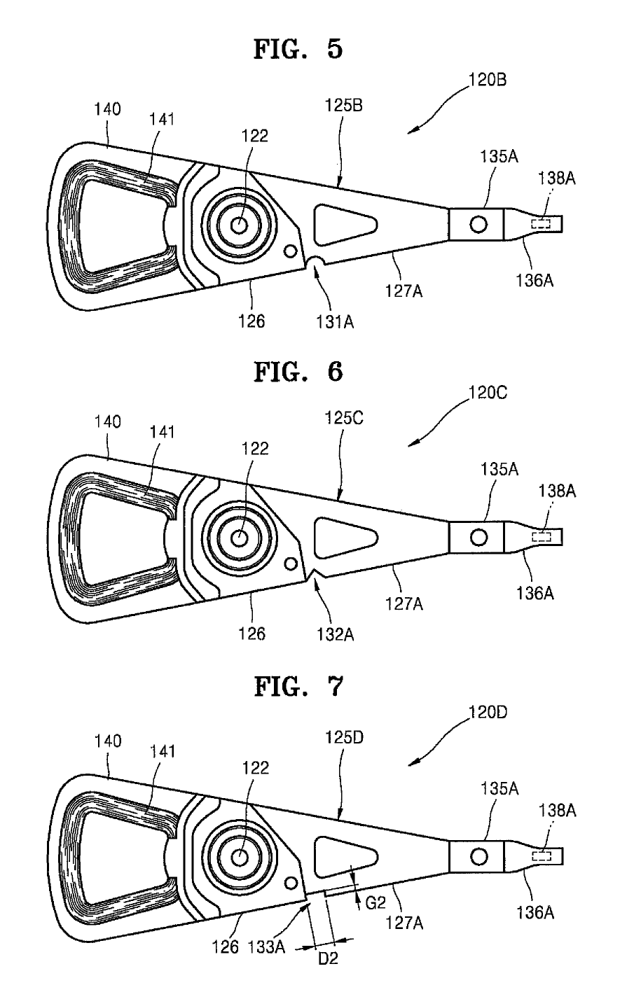

FIG. 3 is a top view of a hard disk drive (HDD) according to an embodiment of the present invention, FIG. 4 is a side view of a head stack assembly (HSA) according to an embodiment of the present invention, and FIGS. 5 through 7 are top views of HSAs according to other embodiments of the present invention.

Referring to FIGS. 3 and 4, an HDD 100 includes a base member 101 and a spindle motor 105, a data storage disk 110, and an HSA 120A. The spindle motor 105, data storage disk 110, and HSA 120A are disposed in a housing (not shown) coupled to the base member 101. The spindle motor 105 is provided in order to rotate the data storage disk 110 at a high RPM and fixed on the base member 101. The data storage disk 110 is coupled to the spindle motor 105 and rotates at the high RPM in a direction indicated by an arrow. The rotation of the data storage disk 110 at a high RPM induces an air flow in the direction indicated by the arrow.

The HSA 120 includes head sliders 138A, 138B, 138C, and 138D each having a magnetic head (not shown) for reading/writing of data. The head sliders 138A, 138B, 138C, and 138D move to a specific track of the data storage disk 110 to read or write the data from or to the data storage disk 110. The HSA 120 includes a swing arm 125A, suspensions 136A, 136B, 136D, 136D coupled to an extreme end of the swing arm 125A with coupling plates 135A, 135B, 135C, and 135D interposed therebetween, and head sliders 138A, 138B, 138C, 138D mounted respectively on extreme ends of the suspensions 136A, 136B, 136C, and 136D. In addition, the HSA further includes an overmold 140 which is coupled to the swing arm 125A and has a voice coil 141.

A magnet 142 and a yoke 144 supporting the magnet 142 are disposed at upper and lower sides of the overmold 140. The magnet 142, the yoke 144 and the voice coil 141 of the HSA 120A constitute a voice coil motor providing a driving force to the HSA 120A.

The air flow induced by the high RPM rotation of the data storage disk 110 passes between the facing surfaces of the data storage disk 110 and the head sliders 138A, 138B, 138C, and 138D and apply a lift to the head sliders 138A, 138B, 138C, and 138D. The head sliders 138A, 138B, 138C, and 138D maintain a floating state at a height where the lift is equal to biasing forces of the suspensions 136A 136B, 136C, and 136D, which bias the head sliders 138A, 138B, 138C, and 138D toward the data storage disk 110. In the floating state, the magnetic heads (not shown) formed on the head sliders 138A, 1388 138C, and 138D read and write data from or to the data storage disk.

The HDD 100 further includes a flexible printed circuit (FPC) 150 electrically connecting the HSA 120A to a main circuit board (not shown) disposed below the base member 101 and a circulation filter 155 for filtering foreign objects such as particles contained in the air flowing in the hard disk drive 100.

The swing arm 125A of the HSA 120A includes a core 126 coupled to the base member 101 with a pivot bearing 122 inserted therein and arm blades 127A, 127B, and 127C extending from the core 126 in a horizontal direction. The coupling plates 135A, 135B, 135C, and 135D are coupled to extreme ends of the arm blades 127A, 127B and 127C by swaging. The suspensions 126A, 136B, 136C, and 136D are respectively attached on the coupled plates 135A, 135B, 135C, and 135D.

The swing arm 125A is provided with blade extension portions (only blade extension portion 128A is shown in FIG. 3) extending respectively from the arm blades 127A, 127B and 127C toward the core 126 in order to prevent the data storage disk 110 from interfering with the rotation of the HSA 120A. The blade extension portion 128A is formed at a portion close to the spindle motor 105 with reference to an imaginary central line L2 connecting a center of the pivot bearing 122 that is a rotational center of the HSA 120A to the head sliders 138A, 138B, 138C, and 138D.

Meanwhile, the arm blades 127A, 127B and 127C are provided with respective rigidity weakening portions to attenuate a difference in rigidity in a lateral direction of the arm blades 127A, 127B and 127C due to the blade extension portions. The rigidity weakening portions are formed by dents 130A, 130B and 130C indented from outer circumferences of the blades 127A, 127B and 127C toward the imaginary central line L2. The dents 130A, 130B and 130C are formed on portions of the arm blades 127A, 127B and 127C, which are opposite to portions where the blade extension portions are formed. As shown in FIG. 3, the dents 130A, 130B and 130C may be formed at boundaries between the core 126 and the arm blades 127A, 127B and 127C. Each dent 130A, 130B and 130C may be formed in a rectangular section in such a manner that a depth D1 of each dent 130A, 130B and 130C is greater than a gap G1. When the depth D1 of each dent 130A, 130B and 130C is greater than ½ of a width W1 of each arm blades 127A, 127B and 127C at a portion where the dent is formed, a rigidity of the portion of each arm blade 127A, 127B and 127C where the blade extension portion 128A is formed may be weakened due to the corresponding dent. Therefore, it is preferable that the depth D1 of each dent 130A, 130B and 130C is less than ½ of the width W1 of each arm blade 127A, 127b and 127C so that only a portion of each arm blade where the dent is formed can be weakened.

The rigidity weakening portion is not limited to the dents depicted in FIGS. 3 and 4. That is, as shown in FIG. 5, the rigidity weakening portion is formed by a semi-circular dent 131A. Alternatively, the rigidity weakening portion is formed by a triangular dent 132A as shown in FIG. 6 or by a parabolic dent (not shown in FIGS). Alternatively, the rigidity weakening portion is formed by a rectangular shape where a depth D2 is less than a gap G2. In FIGS. 5,6, and 7, the reference numerals 125B, 125C, and 125D indicate swing arms having the dents 131A, 132A and 133A.

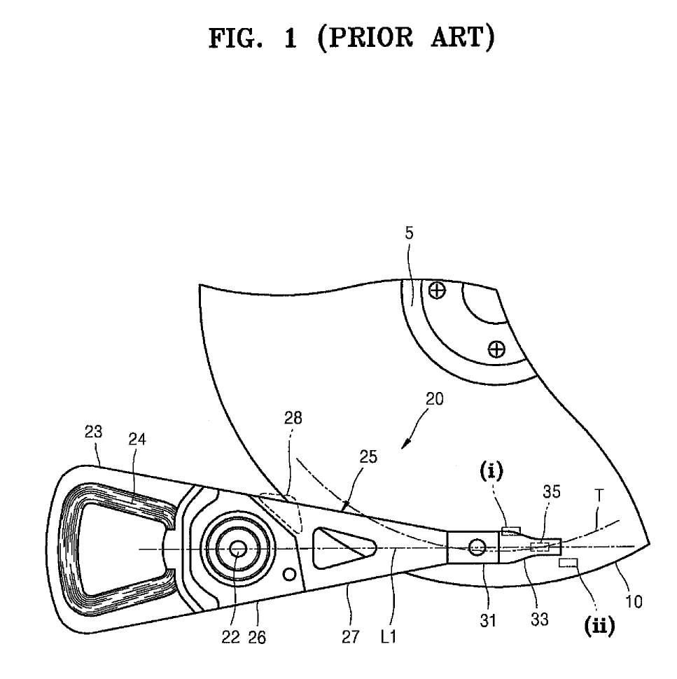

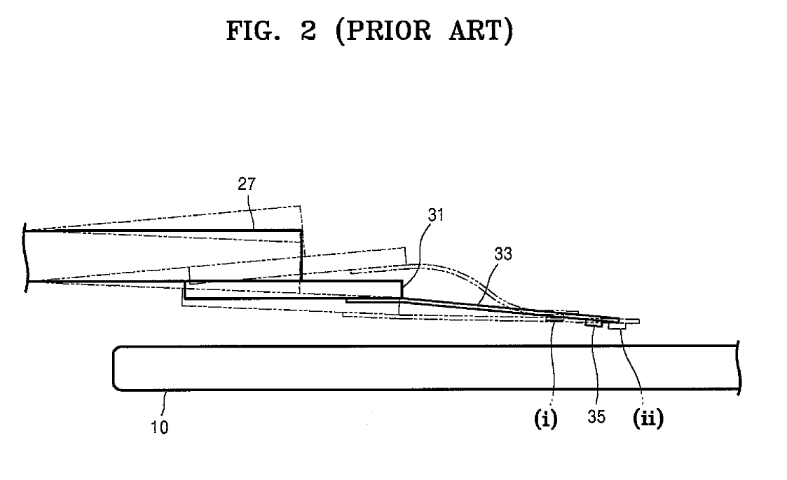

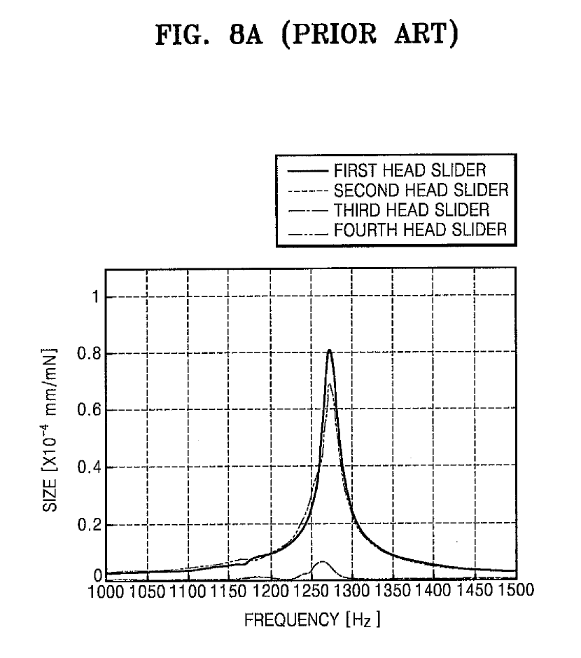

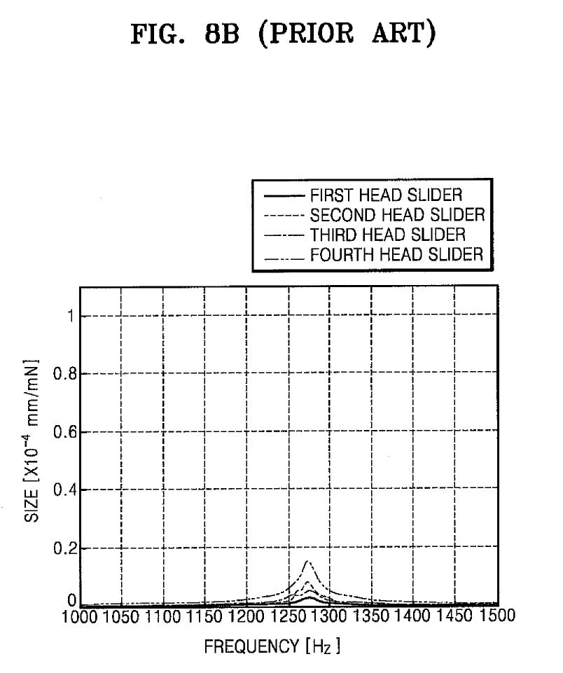

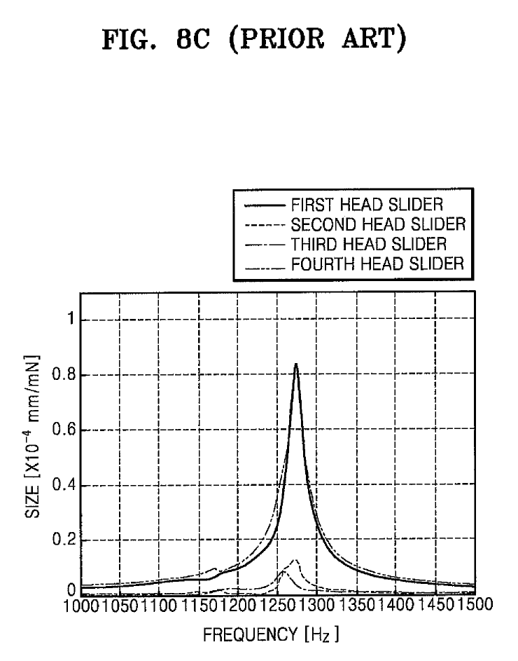

In order to verify the effect of the invention, sizes of the off-tracks caused by the arm bending in the conventional HSA 20, depicted in FIGS. 1 and 2, and in the HSA 120A of the present invention, depicted in FIGS. 3 and 4, were analyzed using computer simulation. FIGS. 8A through 8C are graphs illustrating a simulation result of the HSA 20 of FIGS. 1 and 2 and FIGS. 9A through 9C are graphs illustrating a simulation result of the HSA of FIGS. 3 and 4

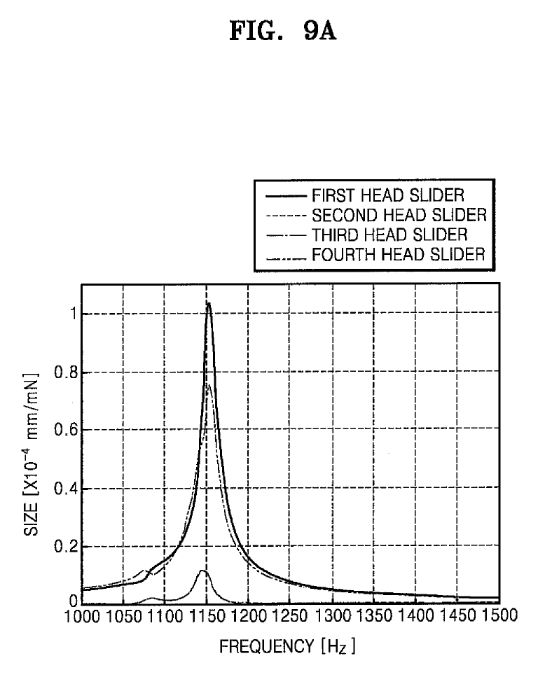

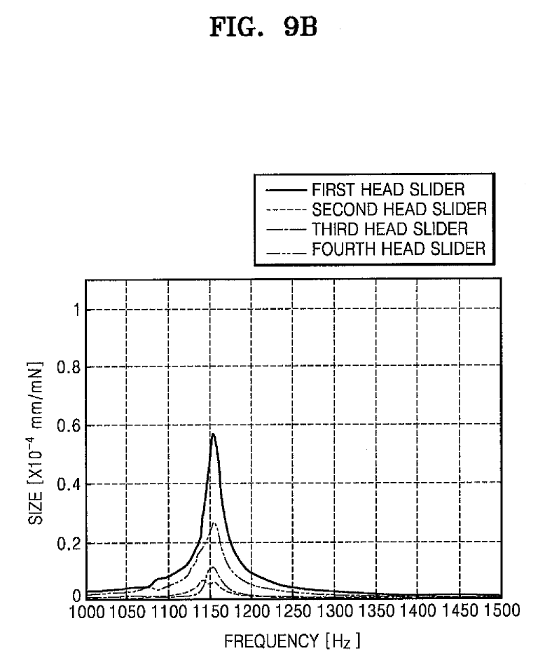

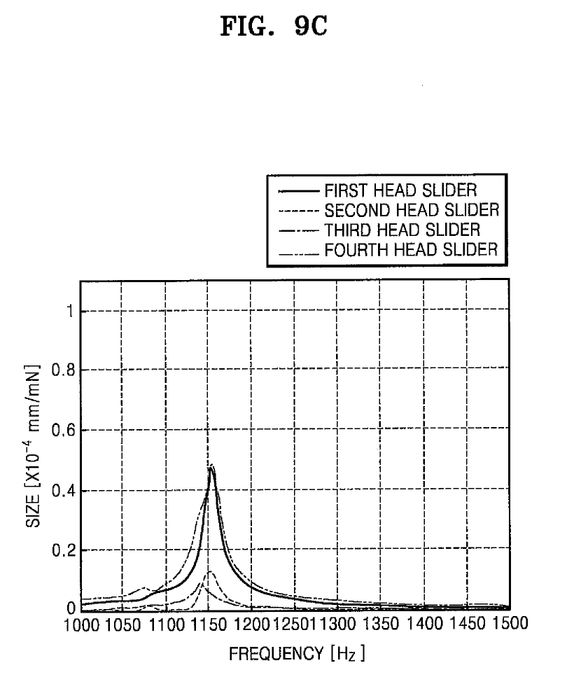

FIG. 8A shows a size of the off-track (hereinafter, referred as “U_{skew}”) caused by the movement of the head slider of the conventional HSA 20 toward the central line L1 due to the arm bending. FIG. 8B shows a size of the off-track (hereinafter, referred as “U_{asym}” caused by the movement of the head slider of the conventional HSA 20 in a direction normal to the central line L1 due to the arm bending. FIG. 8C shows a sum (hereinafter, referred as “U_{Y}”) of the U_{skew} and U_{asym} of FIGS. 8A and 8B. FIGS. 9A through 9C show the U_{skew}, U_{asym} and U_{Y} of the HSA 120A of the present invention, respectively.

For the computer simulation, it was assumed that an HDD having a 3.5 inch diameter disk is used and the depth D1 and gap G1 of the dent 130A of the HSA 120A are 2.4 mm and 0.5 mm, respectively. In the graphs, the X-coordinate indicates a vibration frequency (Hz) applied to the hard disk drive and the Y-coordinate indicates a size (×10⁻⁴ mm/mN) of the off-track. In addition, among the four head sliders, the first through fourth head sliders are in the order of the uppermost to the lowermost.

Referring to FIGS. 8A through 8C, the off-track caused by the arm bending in the conventional HSA 20 was generated at a vibration frequency within a range of 1270-1280 Hz and it was noted that the U_{Y} is greater than U_{skew} because U_{Y} is the sum of U_{skew} and U_{asym}. Referring to FIGS. 9A through 9C, the off-track caused by the arm bending in the HSA 120A of the present invention was generated at a vibration of about 1150 Hz. Although the U_{skew} and U_{asym} of the HSA 120A of the present invention were greater than those of the conventional HSA 20, it was noted that the U_{Y} of the HSA 120A of the present invention is a value obtained by subtracting the U_{asym} from the U_{skew}, which is 40% less than the U_{Y} of the conventional HSA 20.

The off-track reduction effect of the HSA 120A is shown in the following table 1.

TABLE 1

| | Head | | | | |
|---|---|---|---|---|---|
| | Slider | U_{skew}[mm/mN] | U_{asym}[mm/mN] | U_{Y}[mm/mN] | Difference (%) |
| Conventional | Second | 7.9E−5 | 2.6E−6 | 8.2−5 | |
| HSA | Head | | | | |
| | Slider | | | | |
| | Fourth | 6.9E−5 | 1.5E−5 | 8.4E−5 | |
| | Head | | | | |
| | Slider | | | | |
| HSA of | Second | 1.03E−4 | 5.6E−5 | 4.7E−4 | −43% |
| Present | Head | | | | |
| Invention | Slider | | | | |
| | Fourth | 7.4E−5 | 2.6E−5 | 4.8E−5 | −43% |
| | Head | | | | |
| | Slider | | | | |

In the HDD having the HSA of the present invention, since the size of the off-track caused by the arm bending is reduced, the positioning error signal property is improved and thus the data processing speed increases. In addition, tracks per inch (TPI) increase to enable the HDD to have a highly integrated disk.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A head stack assembly (HSA) comprising:
a swing arm including a core pivotally coupled to a base member of a hard disk drive (HDD) and at least one arm blade extending from the core in a horizontal direction;
a suspension extending from an extreme end of the arm blade; and
a head slider mounted on an extreme end of the arm blade for reading and writing data from or to a data storage disk of the HDD,
wherein the swing arm further includes a blade extension portion extending from the arm blade toward the core to prevent an interference with the data storage disk of the HDD, and a rigidity weakening portion formed on a side opposite to that where the blade extension portion is formed to attenuate a rigidity difference in a lateral direction of the arm blade, which is caused by the blade extension portion.

2. The HSA of claim 1, wherein the rigidity weakening portion is a dent formed on the arm blade.

3. The HSA of claim 2, wherein a section of the dent is formed in a shape selected from the group consisting of a triangular shape, a rectangular shape, a semi-circular shape, and a parabolic shape.

4. The HSA of claim 2, wherein the depth of the dent indented from an outer circumference of the arm blade is less than ½ the width of the arm blade at a portion where the dent is formed.

5. The HSA of claim 1, wherein the rigidity weakening portion is formed at a boundary between the core and the arm blade.

6. The HSA of claim 1, wherein the swing arm has more than two arm blades and each of the arm blades has the rigidity weakening portion.

7. The HSA of claim 1, wherein the blade extension portion and the rigidity weakening portion are respectively formed at opposite sides with reference to an imaginary line connecting the head slider and the rotational center of the head stack assembly.

8. A hard disk drive (HDD) comprising:
a base member;
a data storage disk rotating on the base member at a high RPM; and
a head stack assembly (HSA) rotatably mounted on the base member for reading and writing data from or to the data storage disk,
wherein the HSA comprises:
a swing arm including a core pivotally coupled to the base member and at least one arm blade extending from the core in a horizontal direction;
a suspension extending from an extreme end of the arm blade; and
a head slider mounted on an extreme end of the arm blade for reading and writing data from or to the data storage disk of the HDD,
wherein the swing arm further includes a blade extension portion extending from the arm blade toward the core to prevent an interference with the data storage disk of the HDD, and a rigidity weakening portion formed on a side opposite to that where the blade extension portion is formed to attenuate a rigidity difference in a lateral direction of the arm blade, which is caused by the blade extension portion.

9. The hard disk drive of claim 8, wherein the rigidity weakening portion is a dent formed on the arm blade.

10. The HDD of claim 9, wherein a section of the dent is formed in a shape selected from the group consisting of a triangular shape, a rectangular shape, a semi-circular shape, and a parabolic shape.

11. The HDD of claim 9, wherein the depth of the dent indented from an outer circumference of the arm blade is less than ½ the width of the arm blade at a portion where the dent is formed.

12. The HDD of claim 8, wherein the rigidity weakening portion is formed at a boundary between the core and the arm blade.

13. The HDD of claim 8, wherein the swing arm has more than two arm blades and each of the arm blades has the rigidity weakening portion.

14. The HDD of claim 8, wherein the blade extension portion and the rigidity weakening portion are respectively formed at opposite sides with reference to an imaginary line connecting the head slider and the rotational center of the head stack assembly.
